(19) United States
(12) Patent Application Publication
(10) Pub. No.: US 2013/0085987 A1
(43) Pub. Date: Apr. 4, 2013

(54) DOWNLOADING METHOD AND DEVICE

(71) Applicant: QIANG YOU, Shenzhen City (CN)

(72) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/307,530

(22) Filed: Nov. 30, 2011

(30) Foreign Application Priority Data
Sep. 29, 2011 (CN) 201110298476.4

(51) Int. Cl. G06F 17/30

(52) U.S. Cl. 707/609; 707/E17.005

(57) ABSTRACT

A file downloading method applied to a network device, the file downloading device includes a path database to store file types, downloading address, storage paths, and relationships between the file types and downloading addresses and the storage paths; the file downloading method comprises the steps of: selecting a file for downloading; identifying the file type of the selected file; determining whether the file type and the downloading address of the selected file is stored in the storage path database; searching the path database for a storage path if it is determined that the file type and the downloading address of the selected file is stored in the storage path database; and saving the selected file according to the storage path discovered.

### BACKGROUND

1. Technical Field

The present disclosure relates to computer files, and particularly to a file downloading method and device.

2. Description of Related Art

Computer files, including compressed groups of files (zip, rar, etc), MS Word documents, and PDF files, on a server of a network (such as the internet) may be downloaded on to a storage device of a local computer. However, when a user saves the downloaded files on his/her local machine, the user may set a storage path/location for the downloaded file. It is an inconvenience for the user to do that.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of the functioning units of a downloading device.

FIG. 2 is a flow chart of a downloading method.

### DETAILED DESCRIPTION

The disclosure is of a device and method for providing storage paths based on file types and downloading addresses, and automatically storing a file downloaded from a server of a network on a user local machine, according to the provided storage path, based on its file type and downloading address. This is convenient and the method has great efficiency.

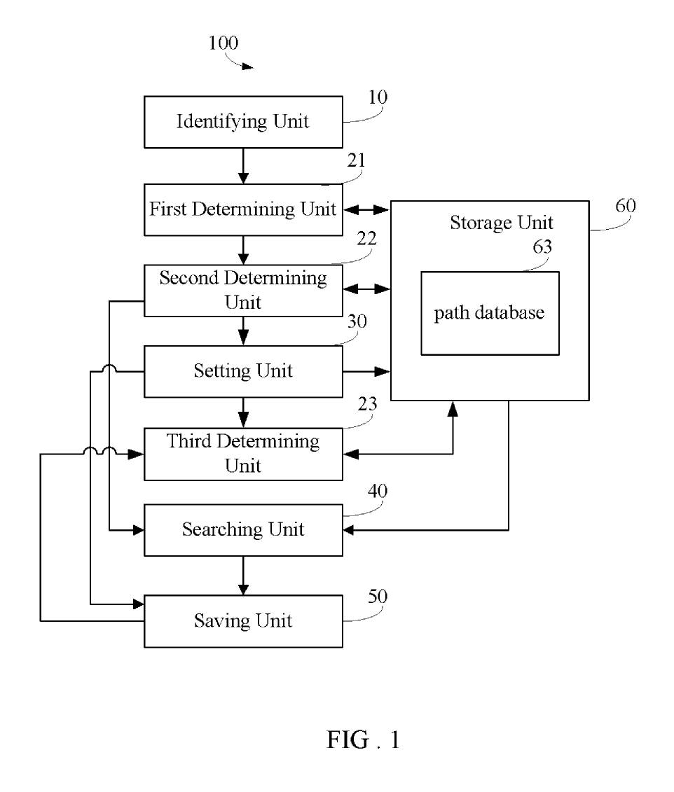

Referring to FIG. 1, the downloading device 100 is capable of storing a file downloaded from a server of a network (not shown). The downloading device 100 includes an identifying unit 10, a first determining unit 21, a second determining unit 22, a third determining unit 23, and a setting unit 30, a searching unit 40, a saving unit 50, and a storage unit 60. In this embodiment, the downloading device 100 is a computer.

The storage unit 60 includes a path database 63. The path database 63 is configured to store file types, downloading addresses, storage paths, and relationships between the storage paths, the file types and downloaded addresses. The file types, the downloading addresses, and storage paths are listed in a table in the path database. Each file type and each downloading address are in accordance with one storage path. The file types may be PDF files, WORD documents. XML files and MP3 files. The download address may be the URL of the site from which the file is downloaded.

The identifying unit 10 is configured to identify the file type of a file to be downloaded from the server of a network. In this embodiment, the identifying unit 10 identifies the file type of the file to be download based on the file extension of the file to be downloaded. For example, the file extension may include keywords indicating the file type. The identifying unit 10 is capable of identifying the file type to which the file belongs based on the keywords.

The first determining unit 21 is configured to determine whether the file type of the file to be downloaded is stored on the path database 63. The first determining unit 21 is further configured to store the file type of the file to be downloaded in the path database 63 and generate a first determining signal when it is determined that the file type of the file to be downloaded is stored on the path database 63, and generate a second determining signal when it is determined that the file type of the file to be downloaded is not stored in the path database 63.

The second determining unit 22 is configured to determine whether the downloading address of the file to be downloaded is stored in the path database 63. The second determining unit 22 is further configured to store the downloading address of file to be downloaded in the path database 63 and generate a third determining signal when the downloading address of the file to be downloaded is stored in the path database 63, and generate a fourth determining signal when the downloading address of the file to be downloaded is not stored in the path database 63.

The setting unit 30 is configured to provie a GUI (Graphical User Interface) for the user to set a storage path of a file to be downloaded in response to either of a second and a forth determining signals.

The searching unit 40 is configured to search the path database 63 for the storage path of the file to be downloaded in response to the first and third determining signals.

The saving unit 50 is configured to save the file to be downloaded according to a discovered storage path or the user-set storage path.

The third determining unit 23 is configured to determine whether the set storage path is stored in the path database 50. The third determining unit 23 is further configured to store the relationship between the storage path, the file type, and the downloading address in the path database 63 when it is determined that the user-set storage path is stored in the path database 50, and store the storage path, the relationship between the file type and the downloading address when it is determined that the user-set storage path is not stored in the path database 50.

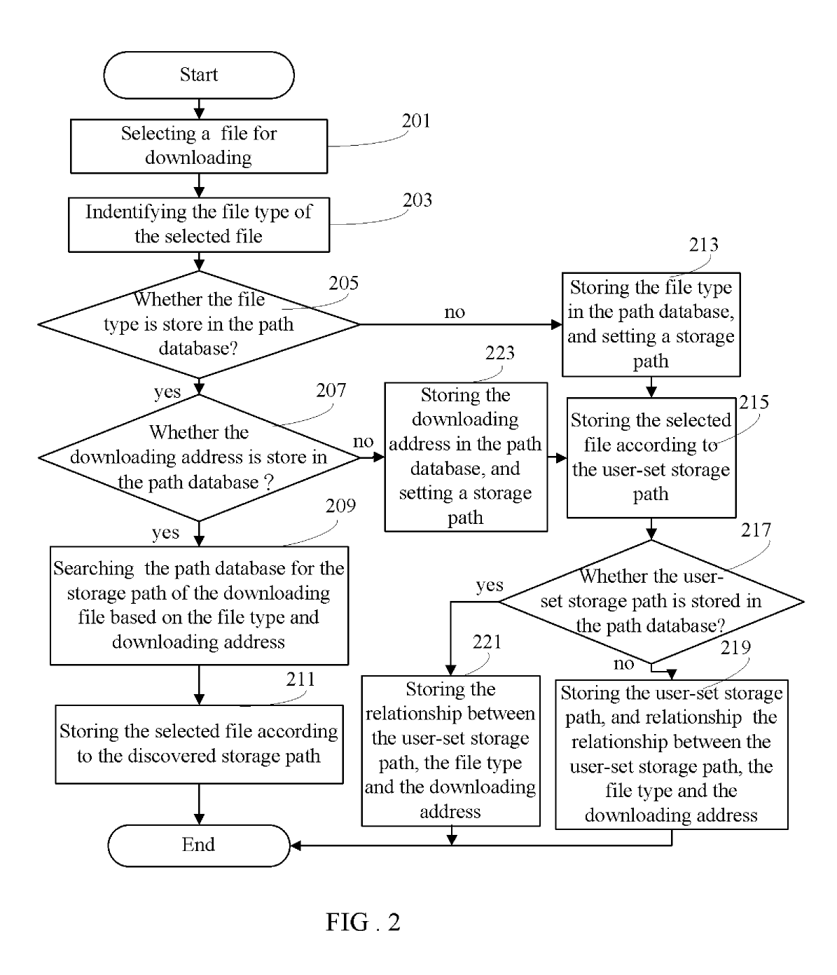

Referring to FIG. 2, the downloading method is applied to a file downloading device. The file downloading device includes a path database to store file types, downloading addresses, and storage paths, and relationship between storage paths, file types, and each downloaded address. One file type and one downloading address are in accordance with one storage path. The downloading method includes the following steps:

In step 201, selecting a file for downloading.

In step 203, identifying the file type of the selected file.

In step 205, determining whether the file type is stored in the path database. When it is determined that the file type is stored in the path database, the process goes to step 207. When it is determined that the file type is not stored in the path database, the process goes to step 213.

In step 207, determining whether the downloading address of the selected file is stored in the path database. When it is determined that the downloading address is stored in the path database, the process goes to step 209. Otherwise, when it is determined that the downloading address is not stored in the path database, the process goes to step 223.

In step 209, searching the path database for a storage path based on the file type and the downloading address of the selected file.

In step 211, storing the selected file based on the discovered storage path.

In step 213, storing the file type of the selected file, and setting the storage path where the selected file is stored.

In step 215, storing the selected file based on the user-set storage path.

In step 217, determining whether the user-set storage path is stored in the path database.

In step 219, storing the user-set storage path, and relationship between the user-set storage path, the file type and the downloading address of the selected file when it is determined that the user-set storage path is not stored in the path database.

In step 221, storing the relationship between the user-set storage path, the file type and the downloading address of the selected file when it is determined that the user-set storage path is stored in the path database.

In step 223, storing the downloading address in the path database, and setting the storage path of the selected file, the process then going to step 215.

As described above, the downloading device and method are capable of automatically storing a file to be downloaded according to a storage path where another downloaded file with the same file type and downloading address of the file to be downloaded has been stored before. Thus, there is no need for a user to set the storage path every time when downloading a file. This is much more convenient for a user and renders the downloading process more efficient. Further, the files to be downloaded are stored based on the file type and downloading addresses, which makes management of the downloaded files also more convenient.

It is to be understood, however, that even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A file downloading device, the file downloading device contained processor to capable of downloading download a file, the file downloading device comprising:
a path database to store file types, downloading addresses, storage paths, and relationships about the file types, the downloading addresses, and the storage paths, any one of the storage paths being configured to save files having an identical file type and downloading from an identical downloading address thereto;
an identifying unit to identify the file type of a file to be downloaded;
a first determining unit to determine whether the file type is stored in the path database;
a second determining unit to determine whether the downloading address of the file to be download is stored in the path database;
a searching unit to search the path database for a storage path based on the file type and the downloading address of the file if it is determined that the file type and the downloading address are stored in the path database; and
a saving unit to store the file to be downloaded according to the discovered storage path..

2. The file downloading device of claim 1, further comprising a setting unit, the setting unit being configured to set a storage path of the file to be downloaded when it is determined that the file type of the file to be downloaded is not stored in the path database, or it is determined that the downloading address of the file to be downloaded is not stored in the path database, and the saving unit being further to save the file to be downloaded according to the user-set storage path.

3. The file downloading device of claim 2, wherein first determining unit is further configured to store the file type of the file to be downloaded in the path database when it is determined that the file type is not stored in the path database; the second determined unit is further configured to store the downloading address of the file to be downloaded in the path database when it is determined that the downloading address is not stored in the path database.

4. The file downloading device of claim 3, further comprising a third determining unit, the third determining unit being configured to determine whether the user-set storage path is stored in the database, and store the user-set storage path and relationship between the file type, the downloading address, the user-set storage path when the user-set storage path is not stored in the path database.

5. The file downloading device of claim 4, wherein the third determining unit further configured to store relationship between the file type, the downloading address, the user-set storage path when the user-set storage path is stored in the path database.

6. A file downloading method applied to a file downloading device, the file downloading device comprising a path database to store file types, downloading address, storage paths, and relationships about the file types and downloading address, any one of the storage paths being configured to save files having an identical file type and downloading from an identical downloading address thereto; the file downloading method comprising step of:
selecting a file for downloading;
identifying the file type of the selected file;
determining whether the file type and the downloading address of the selected file are stored in the storage path database;
searching the path database for a storage path based on the file type and the downloading address if it is determined that the file type and the downloading address of the selected file are stored in the storage path database; and
saving the selected file according to the discovered storage path.

7. The file downloading method of claim 6, further comprising step of:
storing the file type of the selected file in the path database if it is determined that the file type of the selected file is not stored in the path database; and
storing the downloading address of the selected file in the path database if it is determined that the downloading address of the selected file is not stored in the path database.

8. The file downloading method of claim 7, further comprising step of:
setting a storage path of the selected file if it is determined that the file type of the selected file is not stored in the path database or it is determined that the downloading address of the selected file is not stored in the path database; and
saving the selected file according to the user-set storage path.

9. The file downloading method of claim 8, further comprising step of:
determining whether the user-set storage path is stored in the path database; and
storing the user-set storage path, and the relationship between the file type, file downloading address, and the user-set storage path in the path database if the user-set storage path is not stored in the path database.

10. The file downloading method of claim 9, futher further comprising:
storing the relationship between the file type, file downloading address, and the user-set storage path in the path database if the user-set storage path is stored in the path database.
